(19) United States
(12) Patent Application Publication
(10) Pub. No.: US 2017/0061525 A1
(43) Pub. Date: Mar. 2, 2017

(54) PROXIMITY-BASED OBJECT IDENTIFICATION WITH LIVE FEEDBACK

(71) Applicant: Kohl's Department Stores, Inc., Menomonee Falls, WI (US)

(72) Inventors: Charles McCoy, Eagle, WI (US); Vikram Hardi, Glendale, WI (US); Jonah Turner, Grafton, WI (US)

(21) Appl. No.: 15/251,836

(22) Filed: Aug. 30, 2016

Related U.S. Application Data
(60) Provisional application No. 62/213,411, filed on Sep. 2, 2015.

(51) Int. Cl. G06Q 30/06; H04B 1/38

(52) U.S. Cl. CPC G06Q 30/0639; H04B 1/38; H04W 4/008

(57) ABSTRACT

Methods, systems, and devices are disclosed for proximity sensing and guidance of a user to a desired item's or items' location within a place. In one aspect, a system includes a tag device attachable to an item located at a location in a place and including a processing unit, a transceiver to wirelessly transmit a beacon including a code associated with the item and to receive a communication signal from a user device attempting to connect to the tag device based on the code, and an output to generate an output signal to draw attention to the device; and a data processing device to process information about the item from the user device to determine the item and associated code, such that when a user desired item is determined to be the item attached to the tag device, the tag device is operable to produce the output signal.

### CROSS-REFERENCE TO RELATED APPLICATION

This application claims the benefit of U.S. Provisional Patent Application No. 62/213,411, filed Sep. 2, 2015, which is incorporated herein by reference in its entirety.

### BACKGROUND

A department store is a type of retail store that offers a wide variety of merchandise, which is typically organized within different product categories or departments. For example, common departments in department stores include men's, women's and kid's (clothing), home (appliances and goods), furniture, electronics, toys, health and beauty (e.g., including cosmetics, medicine, toiletries, etc.) sporting goods, hardware, automotive, and/or a wide variety of other departments, such as food, books, pets, jewelry and accessories. Typically, department stores employ sophisticated methods and mechanisms to organize and arrange the merchandise in each department in a manner that is both appealing to customers, and convenient for the customer to find desired items. Similar to department stores, grocery stores, drug stores, and to some degree, pharmacies, organize their merchandise like department stores.

### BRIEF DESCRIPTION OF THE DRAWINGS

FIG. 1A shows a diagram of a communication network for providing product proximity sensing and guidance according to the disclosed technology.

FIG. 1B shows a diagram of an example computer device to implement features of the disclosed technology.

FIG. 2 shows a diagram of an example product proximity sensing and guidance system according to the disclosed technology.

FIG. 3 shows a block diagram of an example tag device of the disclosed technology.

FIG. 4A shows images depicting an example implementation of a tag device before and after operation of the indicator signal to alert the user of his/her selected item.

FIG. 4B shows images depicting another example implementation of a tag device before and after operation of the indicator signal to alert the user of his/her selected item.

FIG. 5 shows a diagram of a method in accordance with the disclosed technology to find items in a place based on user selected criteria.

### DETAILED DESCRIPTION

### Overview

Finding a particular desired items among similar looking items or in misplaced locations within a physical establishment (such as a store) can be daunting and frustrating to the point where it may adversely affect or ruin a person's feelings about the item or the experience being at the physical establishment. This can be especially true when shopping at a store. Given the vast assortment of products with different attributes (e.g., size, color, brand, etc.) in many ‘big box’ department stores, grocery stores, drug stores, and other places, it can be challenging for customers and store associates alike, to find certain items of interest efficiently and conveniently, if at all. This problem is exacerbated by the fact that merchandise can be placed tightly together on hangers, in piles, etc. and rearranged or disorganized throughout the day as these products are handled by consumers and store employees.

The disclosed technology provides systems, devices, and methods for assisting a user to find an item the user desires in a particular place, typically organized or scattered among many other items, which is sometimes referred to herein as ‘Find My Stuff’. In some aspects, the disclosed technology includes data processing to determine the user-desired item from user-provided criteria, and proximity sensing of the user-desired item to precisely guide the user to the item in the physical place, e.g., such as a brick and mortar store, and/or identify the item using a signaling response when the user is within proximity of the item.

Techniques, systems, and devices are disclosed for using proximity sensing to guide a user to a desired item or product at a particular location within a physical establishment, e.g., such as within a brick and mortar retail store. A user may first identify a set of preferences for the desired product. As the user gets close to the desired product, live feedback is provided to the user from the physical location of the product to alert the user of the exact location and identity of the desired product. The live feedback can be produced in various human perceivable forms, including visual cues, haptic responses, and audible sounds.

In various embodiments of the technology, an object identification system includes, aspects of the technology include a system for finding items related to user-selected criteria, where the system includes a tag device and a data processing device. The tag device is attachable to an item located at a location within a physical establishment and includes a processing unit to process and store data, a transceiver, an output and a power source. The transceiver can wirelessly transmit a beacon including a code associated with the item and can receive a communication signal from a user device (e.g., a smart phone) attempting to connect to the tag device based on the code. The output is configured to generate an output signal to draw attention to the tag device, while the power source provides electrical power to the tag device. The data processing device includes a processor and a memory to receive information about the item from the user device and to process the information to determine the item and the code associated with the item. The system produces the output signal when the tag device receives data associated with the determined item and the associated code from the data processing device and the user device is within a proximity of the location of the tag device in the place.

Various examples of the technology will now be described. The following description provides certain specific details for a thorough understanding and enabling description of these examples. One skilled in the relevant technology will understand, however, that the technology may be practiced without many of these details. Likewise, one skilled in the relevant technology will also understand that the technology may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the technology. Indeed, certain terms may even be emphasized below; however, any terminology intended to be interpreted in any restricted manner will be overtly and specifically defined as such in this Detailed Description section.

The disclosed product proximity sensing and guidance techniques include processing a set of preferences identified by the user for a desired product to determine and find the location of the product in the place, in real time. For example, as the user gets close to the desired product, the system provides live feedback to the user from the physical location of the product to alert the user to the exact location of the desired product in an identifiable manner. The live feedback can include visual cues, haptic responses, and/or audible sounds.

While the disclosed embodiments are described herein primarily for a brick and mortar store to detect a customer's desired product's location and guide the customer to the product within the store, it is understood that the disclosed embodiments can also be implemented in other places including homes, certain venues, or other types of businesses. Some examples of these places and items therein capable of being identified, located, and providing a signal to the user to find are also described herein.

The disclosed technology provides an in-store technology solution for helping both customers and associates identify merchandise quickly and without intervention by others in the store. In particular, a user (e.g., customer or store associate) can find an item or group of items by selecting criteria on an in-store display device (e.g., kiosk) and/or on the user's mobile device, which triggers a specialized ‘tag’ device attached to the product(s) to selectively provide a visual, audio, and/or haptic response. For example, the tag device can provide feedback or otherwise highlight the user-desired product based on the user's proximity to the tag device, based on a particular signal specific to the user (e.g., color, frequency, and/or cadence of flashing light(s)), or other user-selective method to cause the tag device associated with the user's desired merchandise to provide feedback.

In one example, a customer could select a pair of 36 W×34 L black jeans of a certain brand and cut-style using a software application (“app”) of the disclosed technology (e.g., operable on the in-store display device or on the customer's mobile device), which would relay the data to a data processing unit to determine the location of the selected merchandise in the store and to cause the tag device attached to the pairs of jeans that match this criteria to emit a signal (e.g., visual, audio, haptic) when the user approaches the shelf. In some implementations, for example, the tag devices use Bluetooth Low Energy (BLE) to communicate with the user's mobile device (e.g., smartphone, tablet, wearable communication device, or other wireless communication and computing device). Once the customer inputs the desired product criteria, e.g., such as jeans, 36 W×34 L, black, brand name, cut, etc., in the corresponding app on the user mobile device, the system provides the inputted data to the data processing unit to determine the product or products that match the criteria and to provide the code associated with the determined product or products to the user mobile device. The user mobile device produces a communication interface (e.g., BLE signal in peripheral mode) that would be sent to the BLE receivers in central mode located on the tag device attached to the merchandise. The tag devices attached to the products determined to match this criteria that are in close proximity to the user would produce an identifying signal, e.g., such as light up with a particular indicator signal (e.g., blue light, green light), which can be represented on the user's device via the app. The tag device can be configured to produce a unique indicator signal associated with a specific product, one or more product attributes, or other parameters. In some embodiments, the tag devices are not hardcoded to any particular value, i.e., as a signaling tag device can be programmed to produce a particular indicator signal that can be changed to another indicator signal based on the program or by re-programming. For example, the information about the product that gets stored on each tag device can be updated intermittently by scanning a UPC barcode on the tag device by using a programming device. The indicator signal can include unique identification content, such as a color or series of colors to flash, frequency or cadence of flashing, length of time to remain lit, blinking intensity, etc. Other sensory information (e.g., audio volume, haptic level) could also be stored on each tag and associated with a particular product. In some embodiments, for example, the tag devices utilize BLE circuitry coupled with adaptive software and/or external sensors to maximize battery life. Accordingly, a timeout period can change based on usage or external stimuli. For example, the tag devices could adjust to power saving mode based on time (e.g., based on store hours), or detected ambient light (e.g., once the store is dark after closing), or other based on other criteria or attributes. (The terms “parameters”, “criteria”, and “attributes” are generally used interchangeably herein.)

In some examples, the customer may choose certain criteria to highlight via the tag devices such as only those styles that are of a darker shade, on sale, have a 5-star review, include a recommendation for his/her fit preference, or other criteria that can be processed by the data processing unit to identify the merchandise. Similarly, for example, the disclosed Find My Stuff technology can be used by store associates to isolate specific items while they navigate the store to assemble orders (e.g., “Buy Online, Pick Up in Store” (BOPUS) orders). The disclosed technology not only reduces the amount of time it takes to locate products in the store, but also enables cross-selling and up-selling opportunities by drawing customers' attention to relevant merchandise.

The disclosed Find My Stuff technology can utilize beacons and proximity-based features of the tag devices and customer mobile devices or associate computing and/or communication devices. Existing product wayfinding tools can offer customers/users navigation assistance to particular locations in a store, but the information that they provide is typically only presented to the user on a user device and cannot directly and easily be used to identify individual items on a merchandise display, and therefore do not assist the customer in finding the items supposedly at the directed location. The disclosed Find My Stuff technology can directly identify the product itself (e.g., highlighted via light, sound, or other special effects on a specialized signaling tag, the tag device) based on the attribute(s) chosen by a user. For example, the identification information that is requested by a customer or a store associate is processed to determine the location of the item, and control the tag device to emanate an identifying signal to the specific customer or store associate from the physical merchandise.

Furthermore, some conventional approaches focus on improving the layout of merchandise to appear less cluttered and techniques for reorganizing items that have been shifted throughout the day. However, such conventional approaches to improve layout or manage product shifting do not suffice in keeping the merchandise properly organized. For example, since more product is placed on the sales floor, overall store traffic increases because the additional product requires additional floor space and/or staffing to keep the products organized. In contrast, the disclosed technology is capable of accommodating any existing environment of the store (e.g., the merchandise layout) by bringing immediate attention to items of interest of the customers regardless of where they are placed on a display, which is beyond merely trying to enhance the ways in which products are arranged in stores.

The signals that are transmitted to (and that activate) the Find My Stuff tag devices do not need to originate from an end user's own device (e.g., a mobile application on the user's smart phone or tablet). For example, a store or other physical establishment (e.g., a warehouse) may include computer terminals, touchscreen panels, connected buttons (e.g., “dash buttons” associated with a particular type of item), and/or other devices that are available to end users (e.g., consumers, sales associates, etc.) and programmed to allow any person, particularly one who does not have a phone on his/her person, to leverage the disclosed location identification technology. In such embodiments, consoles or kiosks may be positioned at convenient locations throughout a store to let any user search for a specific item, and then the console or kiosk can communicate with the associated tag device(s) to light up the selected item(s) (e.g., men's XL shirts, shoes on sale, specific shoe brands and/or sizes, clearance racks, etc.). As another example, a store-owned handheld device may be distributed to individual users who are looking to find items from a predefined list, such as a wedding registry or grocery shopping list. As the user walks around the store with the provided handheld device, products with tag devices associated with the list and located on or nearby the user's location may activate (e.g., light up). In addition, the tag devices can be tethered to additional beacons positioned around the store or warehouse, such as beacons positioned on the ceiling or on the floor of a store. This allows a signal from the initial device (e.g., a user's smart phone, a store-provided handheld device, a kiosk, etc.) to be transmitted via the beacons and relayed to the tag device on the specific item(s). In certain embodiments, the beacons can also illuminate or otherwise indicate to users the path from the user's location to the specific item (e.g., by lighting up a path on the floor or ceiling of the store). While some beacon signals are described in detail herein, BLE devices, beacon-like technology, any transport protocols, and related transmitter may be used, and thus use of the term “beacon” is not limiting but covers all methods of communication that can be utilized.

Implementations of the disclosed Find My Stuff technology reduces the amount of time it takes to locate products in store. It can also enable cross-selling and up-selling opportunities to the business operating the store implementing the disclosed technology by drawing customers' attention to relevant merchandise (e.g., matching shirts, similar brands). In certain embodiments, the disclosed technology will increase customer engagement and brand awareness during a customer's in-store experience. For example, rather than overlook nearby merchandise, customers may be inclined to peruse products that have been activated as they walk by a display (e.g., products associated with the product for which the user is looking). Also, for example, the customer may try on extra articles of clothing if they are able to identify his/her particular size more quickly. Moreover, for example, store associates' clock time in fulfilling BOPUS orders is expected to improve, as the technology allows such BOPUS orders can be assembled more efficiently because the locations of exact products are more quickly identified by the store associates via the tags. In addition, the present technology is expect to aid customers in finding products on their own. Implementations of the disclosed Find My Stuff technology are also expected to lead to new and unique insights into customers' shopping behavior as data would be captured for the type, quantity, and frequency of searches performed.

In various embodiments, the systems disclosed herein can also be configured such that a single tag device is registered to or associated with multiple items. For example, one tag device may be associated with and positioned proximate to a display containing a number of the same or similar products (e.g., a light source positioned over or adjacent to a display of products). When the tag device is triggered, the tag device will light up or otherwise indicate to a user the location of the display (e.g., containing multiple similar or identical products), rather than each and every item being highlighted. For example, a tag device can be associated with a shelf or other type of display that includes multiple models of the same blender, and an end user searching for such a blender can locate the blender based on the indicator from the single tag device on the shelf (rather than a tag device on each blending lighting up).

In other embodiments, rather than searching for a specific item, a shopper or store associate may want to identify the location of an entire section of merchandise that has many SKU's assigned to the items therein (e.g., children's pajamas, cosmetics, nail polish, bakery section, seafood aisle). One or more tag devices can accordingly be associated with the specific section of merchandise. As another example, if a user is searching for a specific item (e.g., a specific brand of mustard, a specific size and/or brand of jean, etc.), the tag device in the section of the store containing the selected item (e.g., the condiment aisle, the shelf/shelves with mustard, the denim section, the shelf with a specific size or brand of jean, etc.) can be illuminated to aid the user in finding the desired item.

In still further embodiments, the multi-product tag system can be used in warehouse or stock room setting. For example, one or more tag devices can be associated with an area containing many of the same or similar products (e.g., a region of the warehouse having the same model of toaster, the same brand of toaster, toasters in general, a particular shoe brand, a particular shoe size, a particular shoe model, etc.). A single tag device can also be placed on the exterior of a box containing a particular item so that a user can quickly identify which box contains the items for which the user is looking. As another example, the multi-product tag system can be associated with specific regions in a warehouse or stock room. For example, one tag device can be associated with a section containing a specific brand or type of product (e.g., outdoor gear, a brand of denim, etc.). Embodiments including multiple items or specific areas with multiple items associated with one or more tag devices requires less tag devices than systems in which each individual product is associated with a unique tag device, and therefore such multi-item tag systems are typically more cost efficient. In various embodiments, stores may implement both multi-product tags and single-product tags. For example, these embodiments can facilitate both finding a general region of a store (e.g., the denim section) and a specific product (e.g., a size and/or brand of jean). Another opportunity to save costs is by minimizing how much battery power gets consumed when the tag device is listening for a signal to operate accordingly. This can be accomplished with built-in support of a hardware trigger using RFID or a comparable technology. In this configuration, the tag device can live in a deep, quiescent mode until a received RFID signal creates an interrupt, allowing the device to resume normal functionality.

The disclosed Find My Stuff technology can be applied to a variety of in-store use cases. For example, the present technology can be implemented to help customers identify unique sizes, colors, and styles of clothing, makeup, and/or other products, and can also be configured to show items based on other characteristics, e.g., such as highest rated, best seller, most liked, discontinued, or on sale. In certain embodiments, the disclosed technology can be used to highlight nearby items that have been included within a friend's gift registry. In an example of cross-selling and up-selling opportunities enabled by the disclosed Find My Stuff technology, the data processing unit can activate the tag device(s) attached to a complimentary product or products determined to be related to a particular product, e.g., such as a product or products that ‘complete a look’. Accordingly, a set of neck ties might light up on a neighboring shelf in the store after the customer selects a shirt, e.g., in which the shirt could be a user-desired product initially highlighted using the disclosed Find My stuff technology. Similarly, store associates can accelerate the process of assembling BOPUS orders. Moreover, for example, by capturing data about how customers interact with merchandise around the store, the disclosed Find My Stuff technology is envisioned to provide awareness of the type of items that customers are unable to find (e.g., size 13 shoes) that would aid the store associates in their inventory management efforts.

### Depicted Embodiments

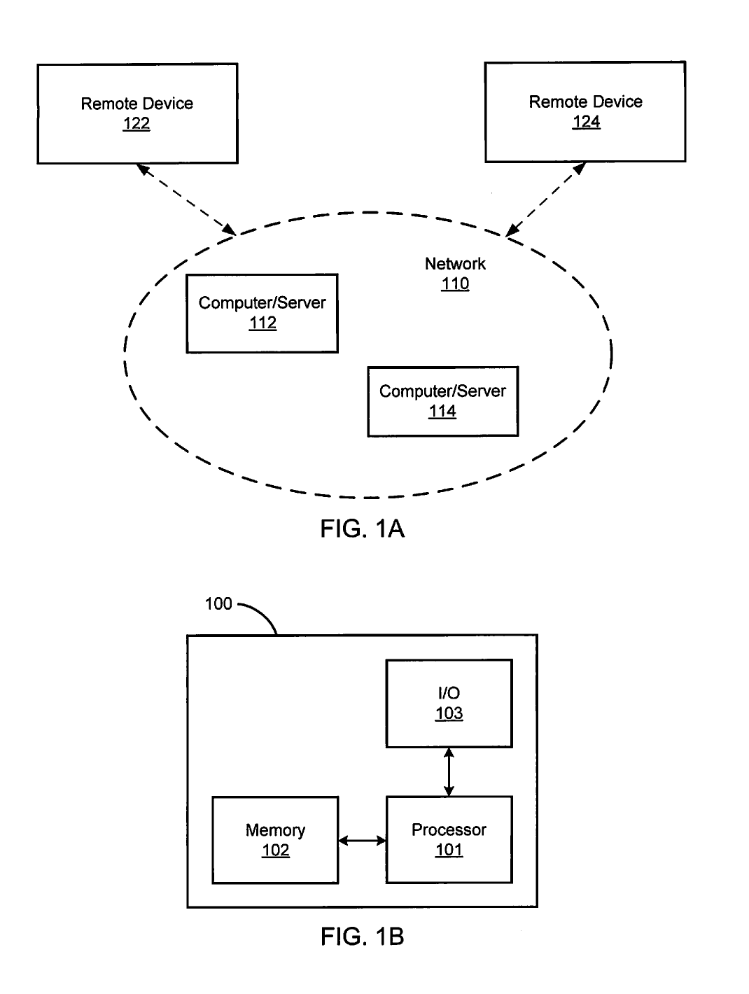

FIG. 1A shows a diagram of an example of a communication network 110 for providing product proximity sensing and guidance according to the disclosed technology. The communication network includes one or more computers or servers 112, 114 that communicate with remote devices 122, 124, which may include user devices and product devices, e.g., the signaling tag devices. The computers or servers 112, 114 in the network 110 can be operated by an entity, e.g., such as a commercial entity selling the desired products (e.g., a brick and mortar store) located in the store. The computers or servers 112, 114 can be located in the store or outside the store. For example, in one embodiment, the computers or servers 112, 114 can include a system of computers that communicatively interact in a communications network (e.g., “the cloud”) to communicate with other computing devices over the Internet. As shown in the diagram of FIG. 1A, the one or more computers or servers 112, 114 are in communication with the remote devices 122, 124 of the individual users (e.g., customers or store associates) to transmit and receive data to and from the user's device, e.g., such as the product information of the desired product to be purchased by the customer. For example, in some embodiments the user remote devices 122, 124 can include mobile communication devices such as smartphones, tablets, and wearable communication devices (e.g., smartwatches, smartglasses, etc.), whereas in other embodiments the user remote devices 122, 124 can include desktop and laptop computers.

The computers or servers 112, 114 can include a data processing engine (e.g., one or more microprocessors) including software modules to perform various functions, such as provide analytics, e-commerce, communication and other types of services for the entity and the individual users. For example, software modules of the data processing engine can reside on the computers or servers 112, 114 operated by the commercial entity. In some implementations, some of the software modules of the data processing engine may reside on the remote devices 122, 124 utilized by the users, e.g., such as in the form of a software application (‘app’) can reside on the remote devices 122, 124 of the individual end users.

As shown in FIG. 1B, an example embodiment of a computer 100 of the computers or severs 112, 114 and/or the remote devices 122, 124 can include a central processing unit, memory unit, and input/output unit, as shown in FIG. 1B. The computer 100 includes a processor 101 (e.g., central processing unit, microcontroller, field-programmable gate array, or other processor) to process data and a memory 102 in communication with the processor 101 to store and/or buffer data. The computer 100 includes an input/output (I/O) unit 103 in communication with the processor 101 that provides wired and/or wireless interfaces (also referred to as communication interfaces) compatible with typical data communication standards for communication of the computer with other computers and computer systems, or external interfaces, sources of data storage, or display devices, among others. For example, the memory 102 can include processor-executable code, which when executed by the processor 101, configures the computer 100 to perform various operations, such as receiving information, commands, and/or data, processing information and data, and transmitting or providing information/data to another entity or to a user. For example, the I/O unit 103 can provide wired or wireless communications using one or more of the following standard communications interfaces, including, but not limited to, Universal Serial Bus (USB), IEEE 1394 (Firewire), Bluetooth, Bluetooth Low Energy (BLE), ZigBee, Z-wave, Weave, IEEE 802.11 (Wi-Fi), Wireless Local Area Network (WLAN), Wireless Personal Area Network (WPAN), Wireless Wide Area Network (WWAN0, WiMAX, IEEE 802.16 (Worldwide Interoperability for Microwave Access (WiMAX)), 3G/4G/5G/LTE cellular communication methods, and parallel interfaces, among others.

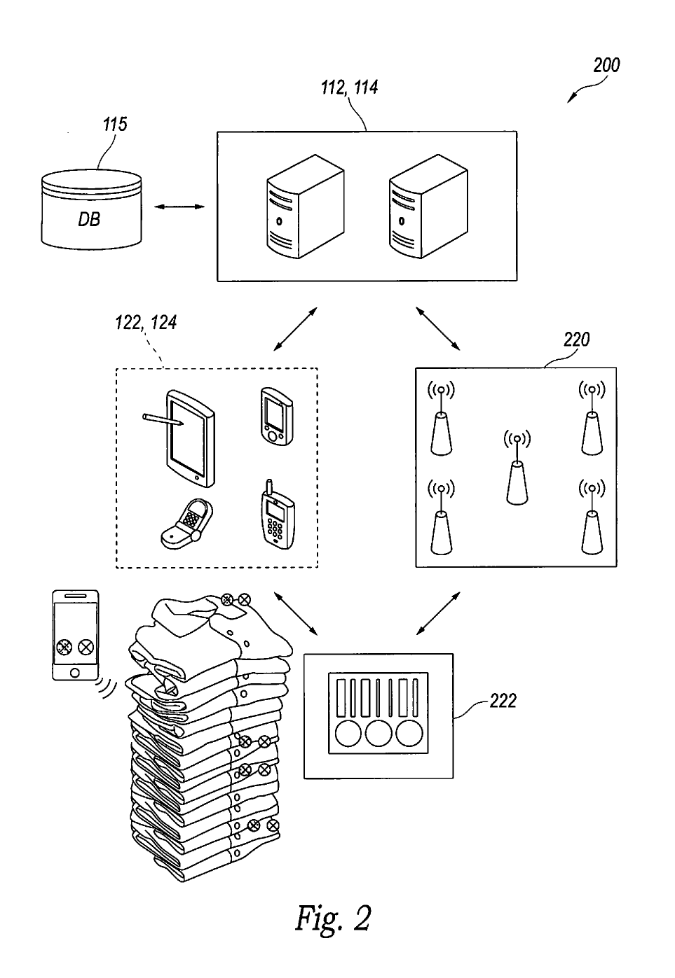

In implementations, the data processing unit, e.g., resident on the one or more computers or servers 112, 114, receives data from the remote devices 122, 124 of the individual users that includes product information based on the user's selected criteria inputted on the app. The data processing unit processes the data to determine what items include attributes that match the user-selected criteria. For example, the one or more computers or servers 112, 114 can include or access one or more databases 115 (FIG. 2) that store information about the items contained in the place or places operated by the entity. The databases 115 can be queried using the user-selected criteria such that the data processing can determine the matched item (or items) and associated data, e.g., including the code presently assigned to the items. In some implementations, for example, the associated data with the determined matched items can include product availability in certain places, location information of the item in the place, and/or complementary product information and associated codes, availability, location, etc. The data processing unit, e.g., resident on the one or more computers or servers 112, 114, transmits the data corresponding to the determined matched items to the remote device 122, 124 of the individual user. The transferred data can include the unique code associated with the matched item and instructions for the remote device 122, 124 to process to produce a beacon (e.g., using BLE) to communicate with the tag device attached to the matched item. Once the communication from the remote device 122, 124 is established with the tag device, the tag device provides the indication signal to alert the individual user to the specific user-desired item to which the tag device is attached. In some examples, the transferred data received by the remote device 122, 124 of the user can include location data of the matched item, such as a graphical map of the item and the user to guide the user to within a certain proximity of the tag device such that the tag device may provide the indication signal.

In some implementations, the “unique” code associated with the matched item can be formatted as follows: [1-ENTITY ID]-[2-COMMAND]-[3-REST OF THE COMMAND]. The entity ID [1] can include symbols or characters to filter packets specific to the entity, thus each entity (e.g., each store) may have a unique ID. The command [2] can be an admin/configuration mode, client mode, or other type of command mode, to thereby command the tag to receive data or commands to be programmed into the tag in the admin/configuration mode, or to inmates feedback in the client mode. The unique code can include additional format fields [3]. In an example of the client mode of command [2], the command portion [3] of the unique code can include the following format: [size/brand/style/class]-[LED1-blink freq-HexColor code]-[LED2-blink freq-HexColor code]. In an example of the admin/configuration mode of command [2], the command portion [3] of the unique code can include the following format: [size/brand/style/class].

As shown in FIG. 2, In some embodiments of the disclosed technology, the remote devices 122, 124 can include the signaling tag devices, depicted as tag devices 222, which may refer to a single tag device or multiple tag devices. In such embodiments, the one or more computers or servers 112, 114 are in communication with the tag devices and can control the tag devices to signal to alert the individual user to the specific item to which the tag device is attached. For example, in some implementations, the signaling tags are in communication with the one or more computers or servers 112, 114 via a central communication unit 220 located in the place where the item is located (e.g., store). The central communication unit 220 can include an array of wireless transmitters or transceivers arranged in various positions the place (e.g., store) to send data to the signaling tag devices attached to the merchandise to control each of the tag devices to signal when selected by the one or more computers or servers 112, 114. In an example, when a user selects the criteria of a desired product on his/her mobile device 122, 124 using the app, the data processing unit of the one or more computers or servers 112, 114 determines the product or products that match the criteria and causes the central communication unit to transmit a control signal to cause the tag device 222 attached to the product(s) to generate the indication signal. The control signal can be transmitted based on various parameters, such as the location data of the user device 122, 124 (e.g., the tag device 222 generates the indication signal when the data processing unit determines that the user device 122, 124 is within a certain proximity of the tag device 222).

FIG. 2 shows a diagram of an example product proximity sensing and guidance system 200 according to the disclosed technology. The system 200 includes the data processing unit, e.g., resident on the one or more computers or servers 112, 114, in communication with the database 115 or data storage. The data storage may be local to the servers 112, 114, or may be located remotely, such as being resident in the cloud. In other words, each store may have its own database and server(s), or each store may have a server that communicates with a remote and centralized database. The system 200 includes the tag devices 222 in communication with the data processing unit. The remote devices 122, 124 of the individual users (e.g., customers, store associates) include a user device software application of the system 200 to provide a user interface that prompts the user to provide criteria data to send to the data processing unit, process data received from the data processing unit (e.g., such as data pertaining to determined items, including the code associated with such items), and operate a wireless communication protocol of the user device to communicate with the specified beacon provided by the tag devices 222 associated with the specified items determined to match the user criteria. In some embodiments, for example, the system 200 can include a communication unit 220 including one or more wireless transmitters or transceivers arranged throughout the place, such that the data processing unit, e.g., resident on the one or more computers or servers 112, 114, may be in communication with the tag devices 222 via the communication unit 220.

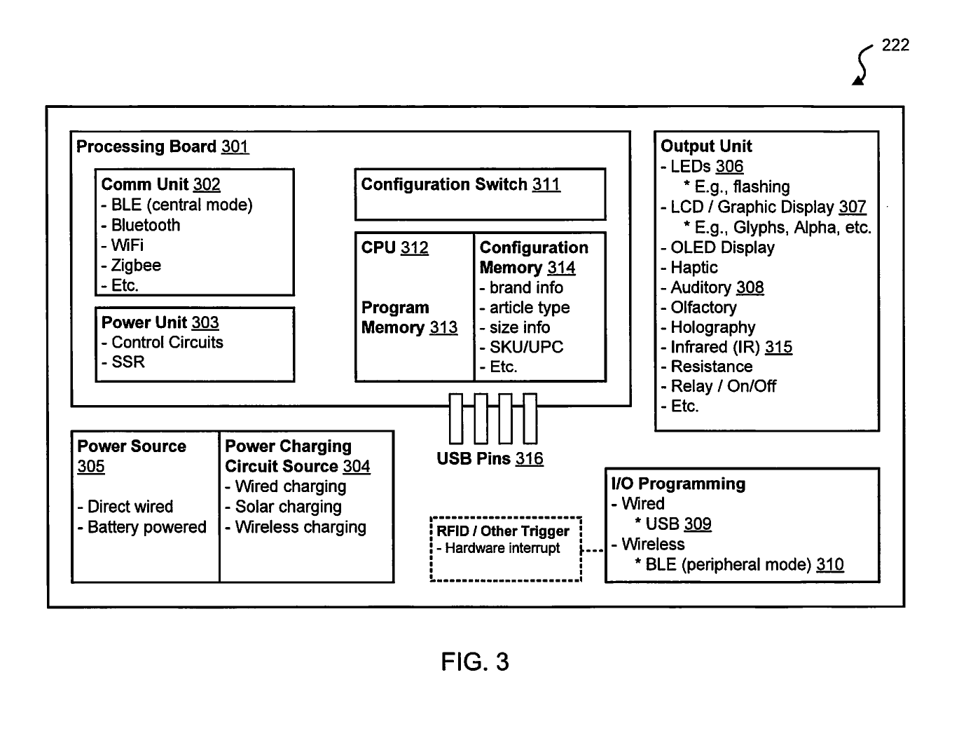

FIG. 3 shows a block diagram of an example of the tag device 222, which can include a processing board 301 including a CPU 312, program memory 313, configuration memory 314 to store and/or buffer the user selected criteria data and determined item data. The processing board 301 includes a wireless communications unit 302 (e.g., BLE (central mode), Bluetooth, WiFi, Zigbee, and/or other), a configuration switch 311, and a power unit 303. The power unit 303 includes control circuits to manage power provided by a power source, e.g., power source 305 and/or charge circuit 304. While shown as a board with separate chips, a system-on-chip configuration can also be employed for some or all chips.

The program memory 313 can be configured to store program instructions executable by the CPU 312 to cause the tag device 222 to perform the various functions of the specialized tag of the disclosed technology. The program memory 313 can be programmed over the air or by Universal Serial Bus (USB). For example, the tag device 222 can be placed on a charger/programmer in a stack configuration such that the USB interface can provide a new program to be installed on that device, e.g., in which the data is transferred via USB pins 316 to the CPU 312 and the program memory 313. This can allow for different programs/updates via charging stands. In some implementations, for example, a security check can be performed to make sure a valid program is stored on the tag device 222 (e.g., signed code, etc.).

The configuration memory 314 can be configured to store a list of attributes regarding a product to which the tag device is attached in a config file, e.g., brand, article (e.g., jeans), size, SKU/UPC, etc. The configuration memory 314 (and/or the program memory 313) can be configured to be programmable, nonvolatile memory. The item attribute data can be sent to the tag device over the air (OTA) or via a wired interface (e.g., such as across USB pins). For example, in implementations in which the data is transferred via USB pins 316, the CPU 312 and the configuration memory 314 are enabled.

The tag device can be configured to have a unique identifying code corresponding to the specific device. The identifying code can be programmed into the device after activation of the configuration switch 311, which enables that specific tag device to be coded. For example, a store associate can activate the configuration switch 311 (which can be a physical switch on the tag device 222, or a virtual switch enabled based on the programming protocol implemented by the store associate) to allow only the specific tag device (or devices that match an attribute) to be coded. The store associate can use a mobile device (e.g., a mobile device running joyn Blackbird) to scan tag of the item, and a programming message is sent to tag device to wipe out an existing configuration and replace it with the new configuration data. In some implementations, the new configuration comes from the reading of an external product attribute database and receiving of attributes. In some implementations, the store associate can add to or overwrite the existing configuration data with additional attributes. The configuration switch 311 can be deactivated to indicate that the configuration process is complete.

The power source 305 can include a direct-wired power source (e.g., USB, DC source, etc.) and/or a battery power source (e.g., disposable batteries, rechargeable batteries, etc.). The power charging circuit source 304 can include a wired charging source (e.g., USB, DC source, etc.), a solar charging source (e.g., photovoltaic cells, etc.), and/or a wireless charging source (e.g., motion generated, stray radio waves, heat based, etc.). Some example charging techniques to charge the tag devices 222 can include a charging bin for wireless based charging sources, or a charging rack that can charge several devices simultaneously that are stacked vertically. Also, some example charging techniques to charge the tag devices 222 can include light based (e.g., solar) charging of the devices. Example power save methods can include management of the tag devices 222 by using an external control device to turn the tag devices ON or OFF (e.g., on when store is open, and off when stores close, based on a timer operated by the CPU 313 of the processing board 301). Another example of the power save methods can include time based polling, e.g., such as polling shorter intervals during active use windows while longer intervals during other times.

The device 222 can include I/O programming to permit external access and allow the device to be programmed or reprogrammed. Wired (e.g. USB 309) and/or wireless (e.g. BLE 310) interfaces may be provided. To minimizing how much battery power gets consumed when the tag device is listening for a signal to operate accordingly, the device may include a hardware trigger using RFID or a comparable trigger technology. In this configuration, the tag device can live in a deep, quiescent mode until a received RFID signal creates an interrupt, allowing the device to resume normal functionality.

In some implementations of the system 200, the data processing unit can be operated using the processing unit of the user devices 122, 124 such that the user device is used to communicate with the tag device 222 directly to find the user-desired product. An example such an implementation of the system 200 including the user device 122 and the tag device 222, shown in FIGS. 2 and 3, is described. For example, a customer selects a pair of jeans having a size of 38 W×34 L using the app on his mobile device 122. The article type and size info attribute data is immediately broadcasted by the mobile device 122 for a certain duration and frequency (e.g., x seconds every y seconds) using a beacon protocol (e.g., encrypted payload). In one example, the beacon protocol can include every (x−1) seconds, the comm unit 302/CPU 312 of the tag device 222 ‘wakes up’ to listen and picks up all BLE (or other wireless (radio)) signals. The tag device 222 ‘looks’ for a specific signal (e.g., including the code), and then matches the transmitted attribute data to the attribute data stored in the configuration memory 314. If there is a match, then the power unit 303 provides power to the output unit (e.g., LEDs 306, LCD 307, etc.) to thereby provide an indicator signal associated with the particular product to which the tag device 222 is attached (e.g., particular LED color, flash rate, text, etc. to light up). Also, for example, the processing board 301 can be configured to operate the indicator signal for a certain duration of time (e.g., turn on an LED timer, then set and allow to expire) to cause the indicator signal to end upon conclusion of the timer. In some implementations, for example, a sleep timer of the tag device 222 can be set to save power of the tag device 222 in emanating its beacon signal and ‘sleeping’ for a certain duration. For example, the sleep timer can be set for (x−1) seconds, such that the power unit 303 turns off the output unit (e.g., LEDs 306). When the sleep timer concludes, the tag device ‘wakes up’ to search for data signals containing its corresponding code and/or emanating its beacon signal providing identification information about the tag device 222.

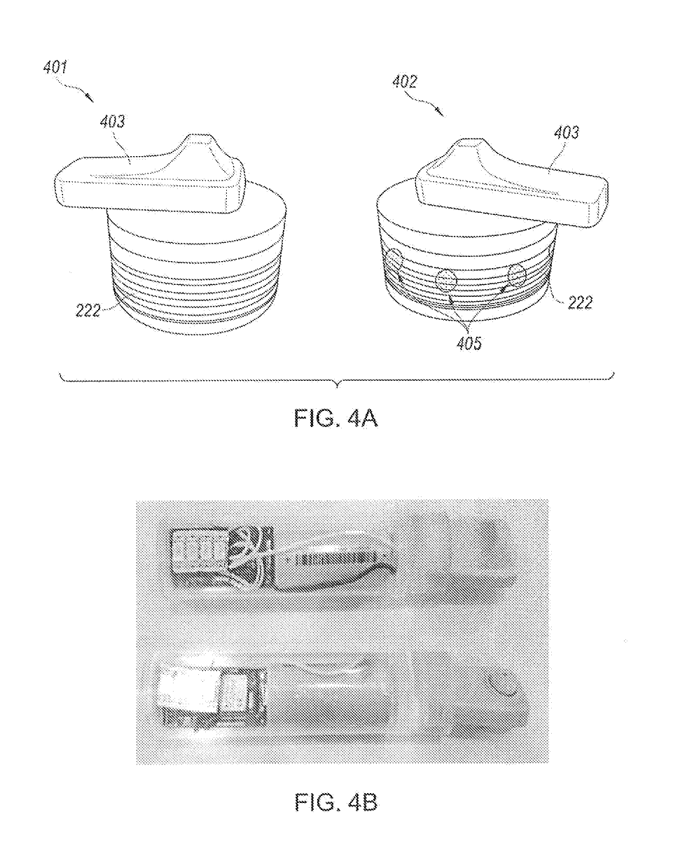

FIG. 4A illustrates an embodiment of the tag device 222 before operation of an indicator signal that alerts the user of the user's selected item (shown by image 401) and after operation of the indicator signal that alerts the user of the selected item (shown by image 402). For example, as shown in the image 401, the tag device 222 is attached to a merchandise security device 403 (e.g., using a standard security pin) that can be attached to a specific product, and operable to produce an indicator signal when user-selected attribute data is matched to the attribute data associated with the specific product. The image 402 illustrates the tag device 222 producing a visual indicator signal via an indicator feature 405 (e.g., LEDs, other lights, etc.) on or in the tag device 222.

In other embodiments of the tag device 222, for example, the tag device can be attached or embedded into existing products such as wearable devices, e.g., smart watches, smart glasses, clothing such as hats, shirts, shoes, etc., accessories such as jewelry, runners' bibs, etc. While a security pin is shown, any type of device to releasably retain the tag device on the product may be employed, not only tamper-resistant devices like security pins.

FIG. 4B shows another example of a tag device 222, with a merchandise security device, battery and different colored LEDs.

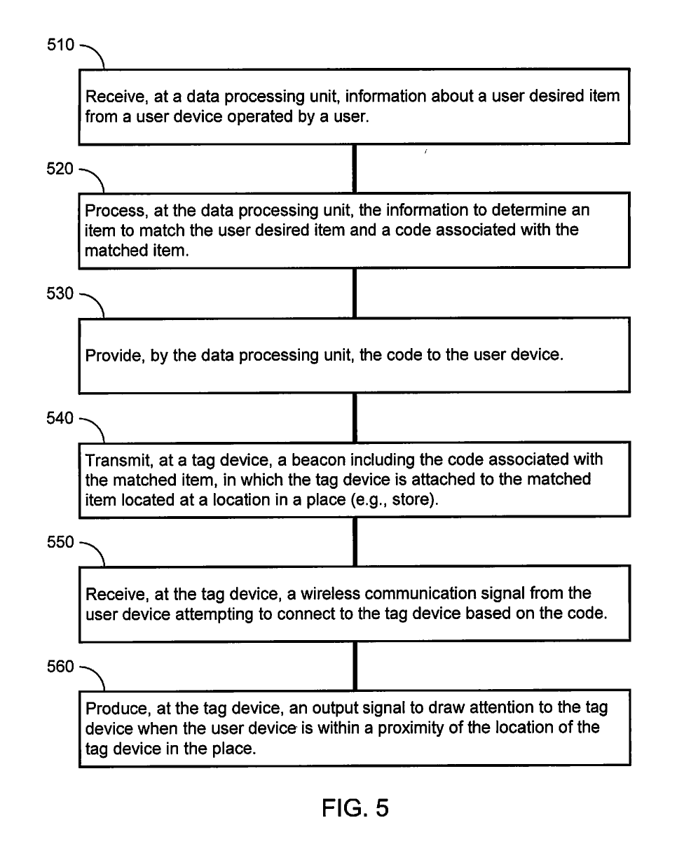

FIG. 5 shows a diagram of a method in accordance with the disclosed technology to find items in a place based on user selected criteria. The method can include a process 510 that causes a data processing unit to receive information about a user desired item from a user device operated by a user. For example, the data processing unit can be at least partially implemented on the one or more computers or servers 112, 114 and/or the user device 122. The method includes a process 520 that causes the data processing unit to process the information and determine an item that matches the user desired item and a code associated with the matched item. A process 530 then provides, by the data processing unit, the code to the user device. For example, the data processing unit implemented on the computer or server 112, 114 can send the code to the user device, e.g., via the communication units 220. The method includes a process 540 that causes a tag device (e.g., tag device 222 of FIG. 2) attached to the matched item located at a location in the place (e.g., store) to transmit a beacon including the code associated with the matched item. In a process 550, the tag device receives a wireless communication signal from the user device attempting to connect to the tag device based on the code. Finally, a process 560 causes the tag device to produce an output signal to draw attention to the tag device when the user device is within a proximity of the location of the tag device in the place.

In some implementations of the method shown in FIG. 5, the user device may use BLE, in peripheral mode, to broadcast a signal to the tag device (which uses BLE, in central mode) in order to find the user desired item or items, and cause the trigger of the output signal. Alternatively, in other implementations of the method shown in FIG. 5, the modes of the communication interface may be flipped such that the tag device is operated in peripheral mode and is able to communicate back to the user device operating in central mode. For example, in this conversation mode, the end user may confirm whether or not an item was identified, count the number of products within proximity, etc. as messages are sent back and forth between the user devices and tag devices. Also, in other implementations, the tag devices are operated in peripheral mode and are programmed to broadcast a message to one or more user devices that are operated in central mode on a scheduled basis. For example, the tag devices can be set to transmit their status and battery levels on a periodic basis (e.g., every night) so that store associates know which ones to replace and when. The disclosed Find My Stuff supports several modes of communication, including one-way communication from the user to tag devices and vice versa, as well as bi-directional communication.

### Exemplary Applications

In some applications, the disclosed Find My Stuff technology can be used to find a specific item or group of like items in a particular place, venue, or environment, where the item or items are organized or scattered among many other items. For example, for a brick and mortar store, a customer or store associate can utilize the disclosed technology to look for merchandise based on a set of attributes such as color, size, style, fabric, brand, price, ratings, clearance, popularity, discontinued, etc.

The disclosed Find My Stuff technology can be implemented in a variety of applications beyond a brick and mortar store to find the specific item or group of items in the particular place. For example, in a parking lot, a driver can utilize the disclosed technology to find an open space, a reserved space, the handicap spaces, places for compact cars only, etc., where the tag devices 222 are attached to signs, the pavement, or other structure associated with the individual parking spaces of the parking lot.

In another example, at a farm, ranch or other agricultural environment, a user can utilize the disclosed technology to find a particular group of crops, or a particular animal, where the tag devices 222 are attached to structures attached to the crop or animal (e.g., via an Animal Identification Number (AIN) for livestock, e.g., which may be instead of ear tag)) or positioned next to the crop or group of crops (e.g., such as a stake). A rancher may implement the disclosed technology to find all cows sired by bull 12367.

In a social setting, such as a conference, a user can utilize the disclosed technology to find people and places with the shared interests and characteristics. Conference attendees can wear the tag devices 222 on their ID badge, etc., that are operable to produce the indication signals when another attendee is in proximity that shares similar interest, e.g., such as all people at a convention who are interested in Big Data and IoT.

In another example, a runner can utilize the disclosed technology to find teammates or certain competitors during a race, e.g., such as find Boston Marathon qualifiers by lighting up those runners' shirts/shoes/bibs/etc. amongst the crowd prior to or during the race.

In some applications, the disclosed Find My Stuff technology can be used to find a collection of items, e.g., in a store or warehouse. For example, in a department store setting, a customer or store associate can utilize the disclosed technology to look for merchandise as part of a list of items such as a wish list, wedding/baby/college registry, omni-channel shopping bag, BOPUS order, items needed for a costume, items corresponding to a complete outfit shown in an ad, etc., e.g., including shopping for products that a customer saved to an online list prior to visiting the store. In another example, in a supermarket setting, a customer can utilize the disclosed technology to find the variety of food and household items added to a grocery list. For example, in a warehouse setting, an employee can utilize the disclosed technology to find items of an order to assemble for shipping (e.g., piece picking implementation).

In some applications, the disclosed Find My Stuff technology can be used to find similar or related items, e.g., in a store or other place like a bar or restaurant. For example, in a department store setting, a customer or store associate can utilize the disclosed technology to look for merchandise that complements or completes a type of purchase, such as completes a ‘look’ for a purchase of clothes (e.g., where a related item such as a matching tie, shirt, belt, shoes, accessories, makeup, sheets, etc. can be signaled to the user in real-time as they pick another item such as a suit). For example, the related item can be selected based on individual purchase history, big data recommendations, previous customer rankings, etc. This can include identifying products that are related by such criteria to an item the customer is sure he wishes to purchase, e.g., such as a customer finding all pieces to make a complete outfit for his wife based on a skirt she liked. In another example, in a grocery store, the customer can utilize the disclosed technology to find the ingredients to complete a recipe or suggested sides/desserts. In another example, in a bar or restaurant, the bartender can utilize the disclosed technology to find the ingredients of a cocktail (e.g., tags on all bottles, so that various bottles are highlighted to indicate which to pour into the cocktail glass) and view amounts to pour on a display screen attached or integrated to the tag device. Similarly, the indicator signal can also be used to encode various information about the cocktail to be made, e.g., such as two red blinks for a double shot, one green blink for a single shot, etc.

In some applications, the disclosed Find My Stuff technology can be used to find a general location of items, e.g., such as in a store, library, or shopping mall. For example, in a department store setting, a customer or store associate can utilize the disclosed technology to look for merchandise in a general area or on a rack/shelf, e.g., such as a customer looking for the clearance rack within a life+style section in a store. In another example, in a library, a patron can utilize the disclosed technology to the section of find books that contain suspense fiction written by Dean Koontz. In another example, in a shopping mall setting, a customer can utilize the disclosed technology to find all the stores that sell men's accessories by flashing a light as the potential customers pass.

In some applications, the disclosed Find My Stuff technology can be used to learn or find out information about user's searches. Such analytics could apply to the other example applications. For example, analytics processing implemented by the disclosed technology can be utilized to uncover new and unique insights into the behaviors of a place's users (e.g., customers and employees), as data would be captured for the type, quantity, and frequency of searches performed by the users. In one example, 13 people tried to find a brand name long sleeve shirt under $15, but to no avail. In another example at a stadium, analytics processing implemented by the disclosed technology can be utilized to find out how many people looked for vegetarian food in the Loge Bleachers. In another example at a pharmacy/drugstore, analytics processing implemented by the disclosed technology can be utilized to find out how many people looked for medicine to alleviate a stomach ache.

In some applications, the disclosed Find My Stuff technology can include techniques to identify specific items in the store involving the use of augmented reality. For example, a user can enter the desired item criteria into a software app of the user device that includes a virtual experience in the store including a layout of store and the user's relative presence in the store, such that the corresponding merchandise would produce an output signal (e.g., light up) on the search device itself through information overlays. In implementations, for example, the technique may require the user to move around in order to capture the range of highlighted products. For example, in such applications, the user device can include wearable smart glasses, that augments the natural visual input seen by the user with the generated output of the store layout and highlighted merchandise determined to be selected/desired by the user.

### CONCLUSION

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

As used herein, the singular forms “a”, “an” and “the” are intended to include the plural forms as well, unless the context clearly indicates otherwise. Additionally, the use of “or” may include “and/or”, unless the context clearly indicates otherwise. The word “or” in reference to a list of two or more items covers all of the following interpretations of the word: any of the items in the list, all of the items in the list, and any combination of the items in the list. Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments. The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Only a few implementations and examples are described and other implementations, enhancements and variations can be made based on what is described and illustrated in this patent document. Overall, many changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

We claim:

1. A system to assist a user in finding items within a physical location containing many other items, comprising:
a tag device attachable to or proximate to an item located at the physical location, wherein the tag device includes:
a processing unit to process and store data,
a transceiver to wirelessly transmit a beacon signal including a code associated with the item and to receive a communication signal from a user device attempting to connect to the tag device based on the code,
an output component to generate a human-perceptible output signal to draw attention to the tag device, and
a power source to provide electrical power to the tag device, wherein the transceiver, output component and power source are coupled to the processing unit; and
a data processing device, including a processor and a memory, to receive information about the item from the user device and to process the information to determine the code associated with the item,
wherein the tag device is operable to produce the output signal when the tag device receives data associated with the item and the code by the data processing device and the user device is within a proximity of the physical location of the tag device.

2. The system as in claim 1, wherein the item is a product for sale within a retail store, and the information about the item includes an attribute of the product or an identification of the product.

3. The system as in claim 2, wherein the identification of the product includes a serial number, or wherein the attribute of the product includes a product name, a brand, an article type, a size, or an SKU or UPC code.

4. The system as in claim 1, wherein the tag device is removably fixed to the item.

5. The system as in claim 1, wherein the data processing device is at least partially implemented on the user device and wherein the user device is a smartphone.

6. The system as in claim 5, wherein the user device is operable to collect the information about the item from the user using the user device by accessing a web page.

7. The system as in claim 6, wherein the data processing device is configured to cause the user device to transmit the information in the communication signal to be received by the tag device, wherein the system implements a wireless protocol in communication between the tag device and the user device including Bluetooth Low Energy (BLE), Wi-Fi, or ZigBee, and wherein the physical location is a warehouse.

8. The system as in claim 7, wherein the collected information about the item includes one or more attributes about the item, wherein the memory of the tag device is configured to store attribute data associated with the item, and wherein the processing unit of the tag device is configured to process the information to determine if the one or more attributes of the collected information match with the attribute data and to determine if the item is a user desired item, such that if the processing unit determines the item is the user desired item then the tag device will produce the output signal.

9. The system as in claim 1, wherein the user device includes a software application to provide a user interface that prompts the user to input the information about the item to be sent to the data processing unit.

10. The system as in claim 1, wherein the data processing device is at least partially implemented on one or more computers in a communication network accessible via the Internet, wherein the data processing unit is in communication with an external database or data storage.

11. The system as in claim 1, where the physical location is within a retail store, and wherein the system further comprises one or more wireless transceivers arranged throughout the retail store and in communication with the data processing unit, wherein the one or more wireless transceivers to transmit and receive data between the one or more computers and the user device.

12. The system as in claim 1, wherein the output component includes one or more LEDs, a display screen, a speaker, a vibrator, a tactile display, or a scent output unit.

13. The system as in claim 1, wherein the power source includes a wired power source receiver including a USB or DC connector, a battery, a capacitor, or a charging power source including a solar cell or a wireless charging unit.

14. The system as in claim 1, wherein the tag device is resident in one or more devices attached to, worn by, or carried by individuals.

15. A method for finding items within a location by user selected criteria, the method comprising:
receiving, at a data processing unit, information about a user desired item from a portable user device;
processing, at the data processing unit, the information to determine an item to match the user desired item and a code associated with the matched item;
providing, by the data processing unit, the code to the user device;
wherein thereafter a tag device attached to the matched item located at a location in a place—
transmits a beacon including the code associated with the matched item;
receives a wireless communication signal from the user device attempting to connect to the tag device based on the code; and
produces a human-perceptible output signal to draw attention to the tag device when the user device is within a proximity of the location of the tag device in the place.

16. The method as in claim 15, wherein the user desired item is a product for sale, and the information about the user desired item includes an attribute of the product or an identification of the product.

17. The method as in claim 18, wherein the identification of the product includes a serial number, or wherein the attribute of the product includes a product name, a brand, an article type, a size, or an SKU or UPC code.

18. The method as in claim 17, wherein the output signal includes one or more flashing lights.

19. The method as in claim 17, wherein the tag device is resident in one or more devices attached to, worn by, or carried by individuals.

20. An apparatus for helping a user to find a desired item among multiple items, comprising:
a housing attachable to or near an item located at a physical location;
a processing unit carried by the housing and configured to process and store data;
a wireless transceiver carried by the housing, coupled to the processing unit, and configured to wirelessly transmit a beacon signal over a first communication interface, and to receive a connection request over the first communication interface,
wherein the beacon signal includes a code associated with the item;
an output unit coupled to the processing unit and configured to generate an output signal; and
a power source to provide electrical power to the processing unit, the wireless transceiver and the output unit;
wherein an external data processing device receives information about a user-desired item, processes the information to determine if the user-desired item is a match to the item, and, if the user-desired item is determined to match the item, sends the code associated with the item; and,
wherein the apparatus is operable to produce the output signal when the apparatus receives the connection request including the code.
